(19) United States
(12) Patent Application Publication
(10) Pub. No.: US 2026/0169811 A1
(43) Pub. Date: Jun. 18, 2026

(54) SYSTEMS, METHODS, AND APPARATUSES FOR NETWORK INTEGRATION

(71) Applicant: Beyond AGI LLC, Austin, TX (US)

(72) Inventors: Pavel Jacko, Westbeemster (NL); Marko Lehtimäki, Hyllykallio (FI); Harri S. Sarsa, Berlin (DE)

(21) Appl. No.: 19/420,752

(22) Filed: Dec. 16, 2025

Related U.S. Application Data
(60) Provisional application No. 63/734,205, filed on Dec. 16, 2024.

(51) Int. Cl. G06F 9/50

(52) U.S. Cl. CPC G06F 9/5027

(57) ABSTRACT

The present disclosure sets forth systems, apparatuses, and methods that enable network integration through reality hosts. A reality host provides a unified semantic interface that transforms information between external devices or software services and a network. The systems, apparatuses, and methods receive device capability information and data, semantically process the data to determine semantic understandings, transmit the understandings to a network, receive commands from the network, and transmit the commands to devices. Reality hosts may perform edge processing for privacy protection and real-time operations while simplifying complexity from the network.

### CROSS REFERENCE TO RELATED APPLICATIONS

This patent claims priority to and the benefit of U.S. Provisional Patent Application No. 63/734,205, filed on Dec. 16, 2024, entitled “Asynchronous Neural Network Interaction System Utilizing Reality Hosts for Enhanced Sensory Integration and Autonomous Communication.” U.S. Provisional Patent Application No. 63/734,205 is hereby incorporated herein by reference in its entirety.

### FIELD OF THE DISCLOSURE

This disclosure relates generally to systems, methods, and apparatuses for network integration.

### BACKGROUND

Networks are often configured to accept certain types of information. But, various devices with which a network may interact do not necessarily output data in compatible forms.

### BRIEF DESCRIPTION OF THE DRAWINGS

FIG. 1 is a perspective view of an example network architecture comprising a cognitive neural network, an executable neural network, a system connect adapter neural network, and a reality access system neural network in accordance with teachings of this disclosure.

FIG. 2 is a perspective view of an example operational topology showing cognitive nodes, execution nodes, system connect adapter nodes, reality access system nodes, and connections, illustrating signal flow in accordance with teachings of this disclosure.

FIG. 3 is block diagram of an example reality host in accordance with teachings of this disclosure.

FIG. 4 is a block diagram of a system comprising the example reality host of FIG. 3 connecting devices with the example network of FIG. 1 in accordance with teachings of this disclosure.

FIG. 5 is a block diagram of an alternate system comprising the example reality host of FIG. 3 connecting devices with the example network of FIG. 1 in accordance with teachings of this disclosure.

FIG. 6 is a flowchart illustrating an example process for implementing the example reality host of FIG. 3 in accordance with teachings of this disclosure.

FIG. 7 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Current networks typically operate within isolated contexts. This is especially true with artificial intelligence (AI) systems and neural networks, which maintain session-based interactions that are limited to individual users or specific tasks. While advancements in neural network architectures, such as Transformers and long short-term memory (LSTM) networks, have extended the capability to retain context over longer sequences, they still face challenges in maintaining a global, persistent state across multiple users and interactions simultaneously.

Existing middleware and integration frameworks, like the Robot Operating System (ROS), may facilitate a connection between AI algorithms and hardware components. While ROS primarily focuses on robotics, other middleware solutions and frameworks in AI and internet of things (IoT) may offer semantic abstraction and standardized interfaces. For instance, frameworks like Apache Kafka for event streaming and the use of semantic web technologies in IoT could be relevant comparisons. These technologies may provide some level of semantic abstraction and integration capabilities.

Additionally, current AI assistants (e.g., Siri, Alexa, Google Assistant) primarily function reactively, though they have begun incorporating features that allow for proactive interactions, such as providing reminders and suggestions based on user context and behavior.

The systems, methods, and apparatuses of the present disclosure, in contrast, enable a network (e.g., neural network) to maintain a continuous, global internal state, allowing it to understand and interact with the external world in a unified and autonomous manner. Such a systems, methods, and apparatuses may extract rules from the complexities of integrating diverse external systems to provide a standardized, semantic interface that enables the network to perceive, reason, and act upon the environment proactively. In some examples, the systems, methods, and apparatuses disclosed herein extract rules from the complexities of physical interactions and standardizing communication protocols to enable networks to perceive, interpret, and affect the environment in a manner akin to human cognition. This architecture may facilitate continuous, proactive engagement with multiple users and systems, enhancing the network's ability to provide personalized, context-aware assistance across a vast array of applications.

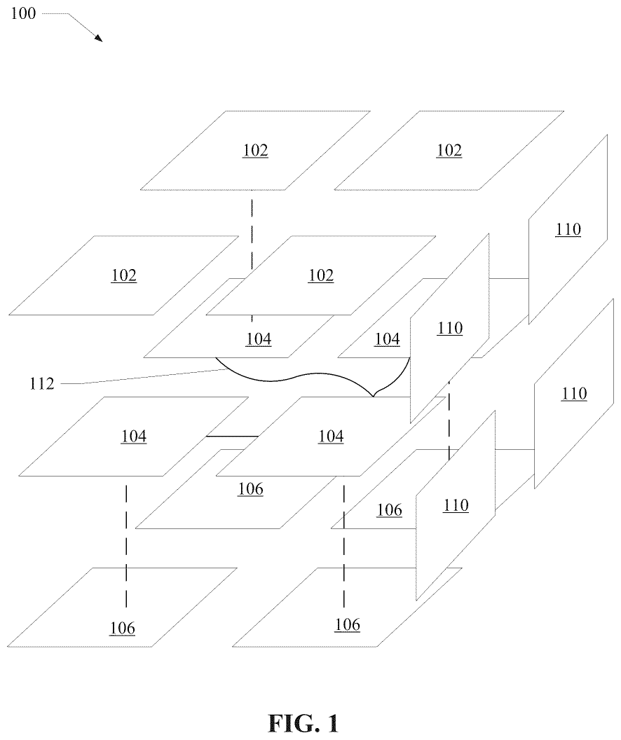

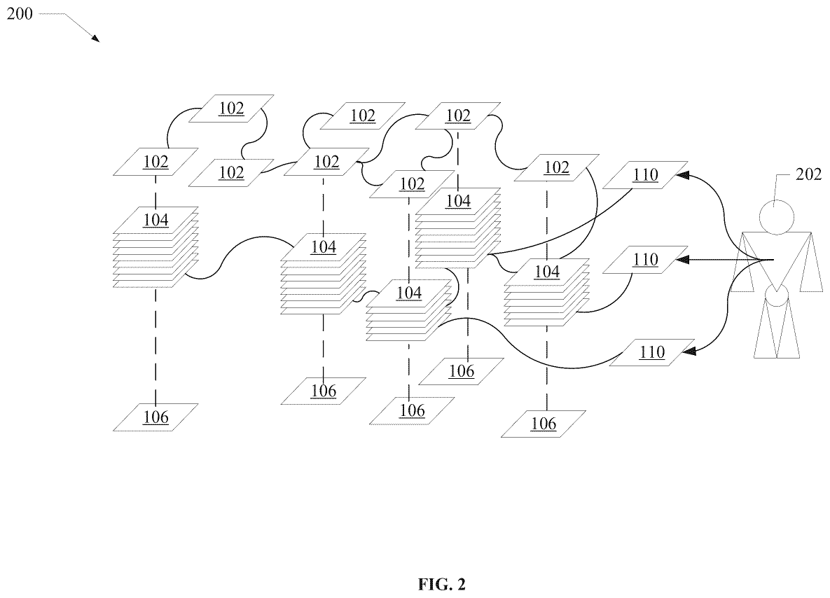

In accordance with the teachings of this disclosure, FIGS. 1-2 set forth perspective views of example generative neural networks 100, 200 comprising a number of neural nodes or instances. The exemplary illustrated neural nodes may be implemented via software as modules. In some examples, the exemplary neural nodes may be associated with corresponding hardware or portions of corresponding hardware. In some examples, each neural node may be associated with its own hardware. In some examples, the neural nodes may be implemented on a device, a system, a local area network of devices, a cloud-based network of devices, an Internet based network of devices, or any combination thereof. The generative neural networks 100, 200 may comprise one or more cognitive neural networks 102, one or more executable neural networks 104, one or more system connect adapter neural networks 106, and one or more reality access system neural networks 110. Each of the one or more cognitive neural networks 102, the one or more executable neural networks 104, the one or more system connect adapter neural networks 106, and the one or more reality access system neural networks 110 may communicate via signals via one or more connections 112.

In some examples, the one or more cognitive neural networks 102 may create relationships in meanings on the neural nodes of the generative neural networks 100, 200, which may enable the neural nodes to communicate efficiently and effectively. In some examples, the one or more cognitive neural networks 102 may adjust (e.g., enrich, reduce, or otherwise change) signals traveling between neurons, which may enable precise and relevant transmission of information. In some examples, the one or more cognitive neural networks 102 may provide timely contextualization for large language models (LLMs), which may enable neurons to better understand and respond to changing conditions. In some examples, the one or more cognitive neural networks 102 may rely on embeddings. The one or more cognitive neural networks 102 may enable long-term memory storage in a compact format.

In some examples, the one or more executable neural networks 104 may comprise a number of nodes that act as executable neurons within the generative neural networks 100, 200. In some examples, the nodes may act as neural logic gates, similar to AND, OR, NOT, NAND, NOR, XOR, and XNOR logic gates in digital circuits. In some examples, the nodes may comprise embeddings, application programming interfaces (API) calls, and LLM GUIs (e.g., OllamaChat). In some examples, a node may communicate with an LLM at a synapse activator, during runtime, at an axion signal router, and/or during axion replication. In some examples, the one or more executable neural networks 104 communicates with LLMs via the one or more system connect adapter neural networks 106. The one or more executable neural networks 104 may control the structure of the generative neural networks 100, 200, including the creation, adjustment, or destruction of neurons.

In some examples, the one or more system connect adapter neural networks 106 may connect various components of the generative neural networks 100, 200 to LLMs, vector entity databases, embeddings, static information, vector memory, API calls, deterministic logic, and the like. The example vector entity databases may comprise NoSQL databases optimized for vector-based data storage and retrieval. The example embeddings may comprise vector representations of words, phrases, and other entities used in natural language processing (NLP). The example static information may comprise fixed values or constants that are generally unchanging. The example vector memory may store and enable retrieval of the vector-based data. The example deterministic logic may comprise pre-defined logic rules or functions that may govern the behavior of the one or more system connect adapter neural networks 106.

In some examples, the one or more reality access system neural networks 110 may connect one or more neurons to the physical world via one or more interfaces. For example, the one or more reality access system neural networks 110 may interface with one or more sensors, input devices, and/or output devices to form reality hosts. For example, the one or more reality access system neural networks 110 may interface with one or more image sensors (e.g., cameras), audio sensors (e.g., microphones), contact sensors (e.g., haptic feedback), software (e.g., Slack), APIs, or the like. In some examples, the one or more reality access system neural networks 110 may interface with external reality hardware and/or software hosts 202 (FIG. 2) such as robots, security systems, appliances, mobile phones, computer networks, autonomous vehicles, and the like. In some examples, portions of the generative neural networks 100, 200 may be offloaded onto the external reality host. In some such examples, a subset of neural nodes of the generative neural networks 100, 200 may be replicated onto the external reality host. In some such examples, the subset of neural nodes may operate in parallel with corresponding neural nodes of the generative neural networks 100, 200.

In operation, the one or more cognitive neural networks 102 may enable the generative neural networks 100, 200 to process and interpret incoming data (e.g., sensory information from the one or more reality access system neural networks 110) and make decisions based on that information. In some examples, the incoming data may be multimodal in that it may come from disparate types of sources (e.g., text, audio, imagery, video, or any combination thereof). In some examples, the incoming data may come from such disparate sources simultaneously and may or may not be related.

In an example of a robotic assistant implementation of the generative neural networks 100, 200, the one or more reality access system neural networks 110 may obtain image (e.g., photos and/or live/recorded video) and audio data relating to a child being severely burned by a flame from a stovetop and interpret that data for processing by the one or more cognitive neural networks 102. The one or more cognitive neural networks 102 may develop a relationship between a node associated with fire and a node associated with injury. In some such examples, the one or more reality access system neural networks 110 may obtain audio data relating to someone calling emergency services (e.g., an ambulance) and interpret that data for processing by the one or more cognitive neural networks 102. In a similar manner, the one or more cognitive neural networks 102 may develop a relationship between the node associated with injury and a node associated with calling emergency services. These specific circumstances may enable the generative neural networks 100, 200 to, in response to receipt of subsequent sensory information indicating a house fire, to identify the potential dangerous circumstances associated with a house fire and, based on data received via the one or more reality access system neural networks 110, based on prior knowledge associating fire with the fire department (e.g., based on a prior association created by the one or more cognitive neural networks 102, based on internet data, based on pre-trained information) and based on location information, determine to alert the proper emergency service (e.g., the local fire department) to resolve the detected house fire. In a similar manner, the one or more cognitive neural networks 102 may determine that the house fire may cause injury to the robotic assistant itself, and determine to navigate the robotic assistant to a safe location (e.g., outside of the house). And, the actions of the robotic assistant (e.g., calling the local fire department and navigating to a safe location) itself may enable the one or more cognitive neural networks 102 to create even further relationships based on whether the determined actions taken were successful, unsuccessful, and to what degree. As such, the generative neural networks 100, 200 may always be adapting and improving based on its interactions with the environment.

In order to interface the one or more reality access system neural networks 110 with external devices and/or software to form reality hosts, the present systems, methods, and apparatuses may create a unified semantic framework that simplifies diverse external systems in order to standardize diverse capabilities and data formats into network comprehendible information. In some examples, the unified semantic framework comprises a semantic abstraction layer that translates raw data into meaningful concepts while preserving temporal-spatial origin information indicating which reality host provided the data, when, and through what embodied experience. Unlike conventional semantic abstraction in middleware frameworks that provide disembodied data translation, this semantic abstraction layer may ground each concept in its experiential source, enabling the network to build an embodied model of reality rather than merely receiving processed data streams. This grounding may enable more sophisticated reasoning and decision-making that accounts for the context, location, and embodied perspective of each data source. In some examples, this framework may enable easier integration of new capabilities and systems, facilitate higher-level reasoning by a network, and enable efficient system scaling by adding new reality hosts and/or adding new capabilities for existing reality hosts seamlessly without underlying architectural changes. For example, a unified semantic framework may enable new devices or diverse systems to be integrated in a plug-and-play approach. In some examples, the framework may be adaptable to varying implementation contexts. In some examples, the unified semantic framework may create a future-ready architecture that supports emerging technologies and standards with forward-compatible design patterns, comprises adaptable interface specifications, enables rapid prototyping and testing capabilities, and overall is a platform for continuous innovation.

In some examples, the formed reality hosts may enhance security and privacy for networks. For example, the reality hosts may provide edge-level security enforcement. The reality hosts may protect sensitive data through local processing and ensure regulatory compliance through appropriate data handling. By enforcing security measures and handling data appropriately at the edge, reality hosts may ensure a system operates responsibly and complies with relevant regulations.

Additionally, the use of reality hosts, such as external reality hosts, may reduce the overall complexity of a network. In some examples, the reality hosts may handle low-level processing and interactions while the network focuses on high-level decision-making. For example, the reality hosts may handle dynamic resource allocation and load balancing. In some such examples, the reality hosts may reduce the computational burden on the network through distributed processing. Such a distributed architecture may enable efficient data flow patterns. In some example, having the reality hosts conduct edge computing may reduce latency for time-critical operations and minimize network dependencies.

In some examples, the reality hosts may perform autonomous operations based on independent decision-making capabilities. For example, the reality hosts may proactively respond to environmental stimuli without explicit commands from a network. In some such examples, the reality hosts may continuously monitor the environmental, adapt in response to detected changes, and initiate interactions based on context. In some examples, the reality hosts may learn through pattern recognition to provide predictive assistance.

In some examples, the systems, methods, and apparatuses described herein present a transformative approach to AI interaction systems by introducing reality hosts as semantic bridges between a neural network with persistent internal state and the external world. Unlike traditional context generation methods that provide disembodied information, reality hosts may enable the neural network to build authentic understanding through direct experiential data. A neural network having the reality hosts described herein may maintain temporal-spatial awareness across physical, virtual, and digital realities, tracking events based on the originating reality host. In some examples, having multiple reality hosts may provide overlapping perspectives, creating a rich and nuanced model of reality through genuine embodied experiences. The neural network can operate continuously and proactively, initiating interactions based on its internal state and the embodied information provided by reality hosts. This design enables asynchronous, autonomous, and multimodal communication, significantly enhancing the neural network's ability to interact with the external world.

To that end, the systems, methods, and apparatuses described herein provide reality hosts for networks to asynchronously, autonomously, and multimodally interact and communicate with the outside world. In some examples, a neural network may autonomously create one or more reality hosts for integration with new or existing devices. In some examples, reality hosts may be created by architects and an architect (or the neural network) may transmit the reality host to new or existing devices to request integration thereof (e.g., through software installation). Once a reality host is integrated with a device, the reality host may be able to process information and initiate actions independently of any user prompts. The example reality hosts may enable a network to monitor an environment continuously, and respond to events in real time. The example reality hosts may proactively trigger network responses based on environmental changes. In some examples, the example reality hosts may continue operation even during temporary network disruptions or periods of high latency.

In some examples the reality hosts, via various sensory inputs and outputs, may enable network to interact with users and systems throughout multiple modalities (e.g., visual, auditory, tactile, combinations thereof, and the like). In some examples, the reality hosts may seamlessly switch between different modalities based on context and/or user preferences. In some examples, the reality hosts may use multiple modal modalities simultaneously for richer interaction experiences. In some examples, other modalities may be used as fall backs to ensure continued operations if primary modalities are unavailable.

To that end, the reality hosts described herein provide a unified, semantic interface that bridges capabilities of a network with diverse external systems, sensors, actuators, etc. Reality hosts may be neural extensions that determine device capabilities and convert externally received information from one form into another for interpretation by networks. In some examples, the networks may be computational networks such as neural networks. In some examples, the reality hosts may be APIs. In some examples, the reality hosts may be software modules configured to interact with existing APIs. In some examples, the reality hosts may be physical devices. In some examples, the reality hosts may be digital devices. In some examples, the reality hosts may be software modules configured to transform information received from physical or digital devices into a form digestible by a network. Unlike conventional tool-based integrations that provide API wrappers for discrete function calls, reality hosts may reframe the interaction such that, for example, the network perceives itself as existing within and sensing through the reality host's substrate rather than merely invoking external functions.

In some examples, the reality hosts may be configured to receive different types of sensory data (e.g., capacitive data, telemetry data, haptics data, audio data, visual data, olfactory data, gustation data), convert the sensory data for interpretation by a network, and communicate the converted sensory data to the network. Additionally, the reality hosts may determine capability information for each device that the reality host is to interact or communicate with in order to understand the type of information that the reality host is to receive from a device (e.g., understand visual data will come from a camera, understand that audio data will come from a microphone, rotational speed data may come from a motor, etc.), as well as understand the type of information the reality host can send to the device (e.g., enable/disable camera or microphone commands, increase/decrease/enable/disable motor speed, etc.).

In some examples, the reality hosts enable a network with a persistent internal state to maintain a global persistent state. Through various users, interactions, devices, and reality hosts associated there with, a network may facilitate continuous internal context to develop a cohesive understanding of the environment and social dynamics. In some examples, reality hosts may enable temporal-spatial awareness through embodied experiences across physical, virtual, and digital realities. In some examples, a network may be able to track and correlate events based on the origin of information from reality hosts, thereby providing authentic contextual grounding. In some examples, reality hosts may enhance a network's memory retention across different contexts, locations, and time periods.

In some examples, reality hosts allow a network to interact with external devices through a unified semantic interface. In some examples, this interface may provide standardized communication protocols that simplify the underlying complexities of diverse systems. In some examples, the interface enables high-level reasoning by translating sensory inputs and desired actions into semantic concepts.

In some examples, reality hosts enable a network to operate autonomously and proactively. For example, reality hosts may allow a network to initiate interactions with users and systems based on its internal state and reasoning processes. In some examples, reality hosts support continuous execution and ‘inner thoughts’ that can trigger actions without external prompts. In some such examples, networks may be able to adapt to changing environments and user needs without manual intervention.

In some examples, a network may be able to handle simultaneous interactions with a vast number of reality hosts, maintaining context and state across all connections. In some examples, a network may be able to integrate new reality hosts seamlessly, regardless of their underlying technologies or vendors, thereby scaling network capabilities through the introduction of new reality hosts. In some examples, the standardization of reality hosts may ensure consistent performance and reliability across different platforms.

In some examples, the reality hosts described herein may be applied to a persistent-state neural network, which may integrate information from multiple sources and retain context over time based on its persistent internal state. In some examples, the neural network may be able to make autonomous decisions. In some examples, the neural network may be deployed centrally. In some such examples, the neural network may be distributed. In some examples, the neural network may reside on a same physical system as its reality hosts, enabling edge deployment scenarios with reduced latency. Unlike traditional context generation methods that provide disembodied information, the systems, methods, and apparatuses described herein may ground a neural network's understanding through direct experiential data from reality hosts. In some examples, the neural network may build a rich temporal-spatial model of reality by correlating events with their source reality hosts, enabling it to understand not just what happened, but where, when, and through which reality host's embodied experience.

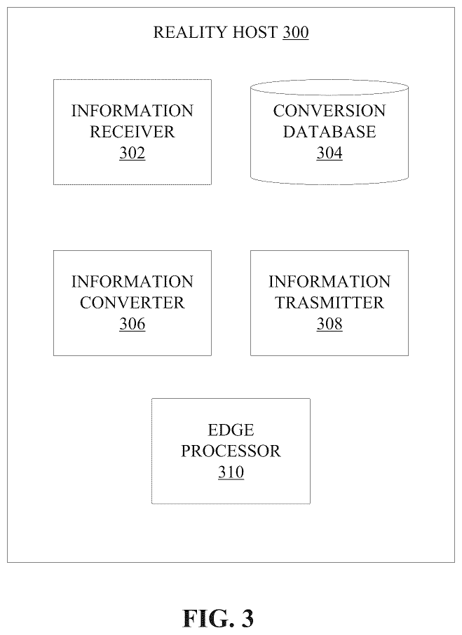

The example reality hosts may provide a standardized, semantic interface to external systems, sensors, and actuators. In some examples, the standardized interface may comprise a host link protocol that establishes the communication channel between reality hosts and the network. In some examples, the host link protocol may be implemented via web sockets, HTTP, or other real-time communication methods. The reality hosts may simplify, though semantic abstraction, complexities of physical interactions, which may allow a neural network to operate at a higher cognitive level without dealing with low-level protocols or device-specific details. An example reality host 300, which may be an implementation of a reality access system neural network 110, is shown and described with reference to FIG. 3. The example reality host 300 may be a software module, a hardware device, a virtual interface, a biological organism, or any other system, method, technique, or technology that extends a network's capabilities beyond traditional input-output mechanisms. In some examples, the reality host 300 is implemented as a standardized interface for communication between a network and numerous external devices. In some such examples, the standardized interface enables compatibility and simplification during integration of new devices, regardless of the underlying hardware and/or software of the new devices. In some examples, a single reality host 300 may connect with multiple external devices. In some examples, each device to which a network is to interact and communicate with may have a dedicated reality host 300 for that device. In some examples, the amount of reality hosts may be limited only by the computational capacity of a network (e.g., the executable neurons). For example, a network may interact with and receive information from as many reality hosts as the network can computationally process serially or in parallel. The example reality host 300 of FIG. 3 may comprise an information receiver 302, a conversion database 304, an information converter 306, an information transmitter 308, and an edge processor 310.

The example information receiver 302 may receive information from various types of external devices, systems, database, software, services, etc. In some examples, the information receiver 302 may comprise a physical connection, a wired communication protocol, a wireless communication protocol, or any combination thereof. In some examples, the example information receiver 302 may access, via an API, a location or database to receive information. For example, the information receiver 302 may access and understand a GitHub repository. In some examples, the information receiver 302 may be a Docker container deployed inside a private network. In some examples, the information receiver 302 may receive contextual information about an environment, a user, a user's activities, system states, etc.

The example conversion database 304 may comprise semantic conversion concepts and/or conversion tools (e.g., Style Dictionary). In some examples, the conversion database 304 may store semantic conversion concepts in association with temporal-spatial origins. In some examples, the example conversion database 304 may store input output pairs for orchestrating conversion of certain input data types to certain output data types. In some such examples, these input output pairs may be stored in a look-up table. In some examples, the example conversion database 304 may store conversion concepts for an individual device. In some examples, the example conversion database 304 may store conversion concepts for multiple devices. In some examples, the conversion database 304 may store received information prior to or after conversion. For example, the conversion database 304 may store received contextual information for future use, decisions, or behaviors. In some examples, the conversion database 304 may store reality host capabilities. In some examples, the conversion database 304 may update capability status in real time.

The example information converter 306 may use semantic conversion concepts stored within the example conversion database 304 to convert information received from the information receiver 302 into a form compatible with the network for which the reality host 300 is configured. To accomplish this, the information converter 306 may convert the received information into semantic tokens. In some such examples, this conversion may comprise breaking down the information into tokens (e.g., words, subwords, or characters) and vectorizing the tokens into embeddings. For example, physical sensor data may become semantic tokens like “room,” “Building,” “lobby,” “occupied,” “temperature,” “warm,” “customer,” “north entrance,” “air,” “poor,” “access,” “authorized,” “package,” “delivered,” etc. In some examples, the conversion process may further comprise applying domain-specific inference models (e.g., image recognition, audio classification, or sensor pattern analysis) to extract semantic meaning from raw data that may not be able to be directly tokenized. In some examples, the information converter 306 may fuse data from multiple modalities or sensors to generate unified semantic representations. In some examples, the information converter 306 may tag each semantic token or understanding with temporal-spatial origin metadata indicating which reality host, sensor, or device provided the underlying data, when the data was received, and through what modality, thereby preserving embodied context for the network's unified reality model.

The information converter 306 may combine semantic tokens into semantic understanding such as “room is occupied,” “room is too warm,” “air quality poor,” “unauthorized_access_attempt,” “package_delivered,” “room temperature in Building A's lobby is 22° C./72° F.,” or “customer entered through north entrance.” In some examples, the information converter 306 may provide embodied context with its converted information. For example, “motion was detected at the north entrance and customer was identified based on mobile Bluetooth signal increasing towards north entrance and decreasing after passing through north entrance.”

In some examples, the information converter 306 may query an inference engine to convert raw data into a form understandable by the network. In some examples, the information converter 306 may be implemented via specific pretrained models (e.g., image recognition or repository validation models). The information converter 306 may therefore translate or otherwise convert raw information into semantic concepts that a network may understand. In some examples, temporal events and spatial data may be mapped to neural-network-comprehensible concepts.

The information converter 306 may also translate a network's high-level intentions and translate them into concrete actions in the external world. For example, complex capabilities may be exposed as high-level intentions such as “clean this room,” “adjust_climate(desired_conditions),” “optimize_energy(),” “lock_all_doors(),” “arm_system(),” “sound_alarm(),” “notify_user(message),” “get_user_preference(topic),” “adjust_parameters(settings),” “emergency_shutdown(),” “inspect_product(),” “adjust_quality_parameters(),” “order_supplies(),” and “optimize_resource_allocation(),” “alert_staff(condition),” and “adjust_treatment(parameters),” “update_records(),” and “retrieve_history(patient_id),” “schedule_consultation(),” “coordinate_care_team(),” or other high-level commands. In some examples, these high-level commands may enable a device to perform a number of sub-commands autonomously without further input from the network in order to perform the high-level command.

In some examples, the information converter 306 may also translate a network's low-level intentions and translate them into concrete actions in the external world. For example, complex capabilities may be exposed as low-level intentions such as “activate motor 1,” “incrementally raise temperature setting,” “actuate lock mechanism,” “send HTTP request,” “authenticate request,” “trigger speaker to emit frequency X,” “send SMS message,” or other low-level commands. In some examples, each of these low-level commands may enable a device to perform a single sub-command, such that multiple low-level commands may be issued in order to perform an action. In some examples, the information converter 306 may be translate a network's intentions into a combination of high and low level commands.

The example information transmitter 308 may transmit the converted information from the reality host 300 to the network for which the reality host 300 is configured. In some examples, the information transmitter 308 may transmit raw, unprocessed, unconverted information to the network. In some examples, the information transmitter 308 may transmit raw, unprocessed, unconverted information simultaneously with the converted information to the network. In some examples, various levels of converted/nonconverted information may be transmitted to the network. In some such examples, the network may transmit requests for specific levels of conversion of the information, to which the information transmitter 308 may appropriately respond. The information transmitter 308 may transmit device capabilities to the network such that the network may be able to understand how the network may be able to utilize the device. In some examples, the information transmitter 308 may transmit device capabilities through semantic descriptions. The information transmitter 308 may transmit other device information to the network such that the network may be able to understand what information the network may receive from the device. For example, the information transmitter 308 may send contextual information about an environment, a user, a user's activities, system states, etc., which may allow the network to tailor interactions and actions appropriately.

In some examples, the information transmitter 308 of a first reality host 300 may transmit information (e.g., contextual information) to the information receiver 302 of a second reality host 300. In some such examples, cross-reality host context sharing may enable coordinated responses across the system, may form direct peer connections for time-sensitive operations, may manage shared state for related capabilities, may enable resource sharing between compatible reality hosts, and may allow networks to orchestrate multiple reality hosts through high-level intentions.

In some examples, the information transmitter 308 may also issue commands to connected devices. For example, the information transmitter 308 may transmit commands to devices to implement the concrete actions translated by the information converter 306. In some examples, varying levels of commands may be issued to devices. In some examples, the network may be able to send commands to a device for every action that the device is going to perform. For example, an example autonomous vacuum may perform hundreds to thousands to commands in order to perform actions such as move forward, turn, enable vacuuming, determine a distance to travel, determine an object obstructing a path, determine a mapping of an environment, determine a location of a dock, align a dustbin with a repository, charge battery, etc. In some such examples, the network may be able to communicate with the autonomous vacuum to analyze sensor data, logically determine a next step to accomplish one or more of the various actions, and issue commands to the autonomous vacuum for performance of such actions. In some such examples, continuous network communications and constant two way communications may be necessary. In some such examples, many different types of data from the vacuum may be converted for the network to analyze (e.g., lidar/radar data, camera data, GPS data, battery level, motor 1 rotations per minute, motor 2 rotations per minute, vacuum suction on/off, dustbin location, ejection, etc.), and many different types of commands may be converted and transmitted to the vacuum for performance thereof.

In some examples, the network may be able to send general commands to a device, and that device may be able to perform various actions based on those general commands. For example, using the autonomous vacuum cleaner example, the network may determine a location in which the autonomous vacuum should perform cleaning. The network may be able to send a single command to clean that certain location, and based on that single command the autonomous vacuum may perform navigation and obstacle avoidance to arrive at the location, perform vacuuming, return to the dock, and empty the dustbin. In some such examples, the device may accomplish various routines from a single issued command. In some such examples, minimum data from the vacuum may be converted for the network to analyze (e.g., command accepted, command executed), and minimum commands may be converted and transmitted to the vacuum for performance thereof (e.g., clean location X, Y). In such examples, the network may be able to accomplish a similar result as the first example, with less network communications. However, the network may be able to interact with any devices generally (e.g., a few high level commands), specifically (e.g., commands single decision), or somewhere in between.

The example edge processor 310 may handle real-time processing and/or immediate reactions to received information to enable time-critical operations without network involvement (e.g., robot navigation). In some examples, the edge processor 310 may transform raw sensor inputs into high-level semantic concepts. In some examples, the edge processor 310 may perform initial processing on the received information for privacy protection. For example, the edge processor 310 may obfuscate sensitive data such as by anonymizing user data (e.g., employee records). In some examples, The edge processor 310 may transform raw data into privacy-preserving representations. The edge processor 310 may filter personally identifiable information, validate and sanitize all input formats, implement data minimization principles, and/or handle authentication and authorization.

In some examples, the edge processor 310 may determine local commands for immediate implementation. For example, the edge processor 310 may process data requiring real-time responses to avoid delays from forwarding the data to the network for processing. In some examples, the edge processor 310 may implement output safety controls to ensure network commands do not create dangerous conditions. For example, the edge processor 310 may constrain network commands to be within hardware-level safety limits (e.g., force sensors), to comply with physical boundaries, to limit rates, to gradually actuate motors, etc. In some examples, the edge processor 310 may issue emergency stop commands. The edge processor 310 may implement multi-stage validation for dangerous operations. In some examples, the edge processor 310 may implement rollback mechanisms and/or redundant safety systems. In some examples, the edge processor 310 may maintain separate security domains, implement neural-network-independent fail-safes, monitor and log all interactions, and adapt security policies to environment.

In operation, the information receiver 302 may receive device capabilities and raw information from a device. Based on the device capabilities, the information converter 306 may determine one or more conversion mechanisms from within the conversion database 304 to apply to the raw information to convert that raw information into network conforming information or signals. The information transmitter 308 may send, to the network, the device capabilities, the raw information, and/or the converted network conforming information or signals. In some examples, the edge processor 310 may perform immediate processing on the raw information for privacy protection, real-time decisions, and real-world complexities.

The information receiver 302 may receive one or more commands from the network. In some examples, the information transmitter 308 may send, to the device, the one or more commands. In some examples, the information converter 306 may convert the one or more commands from the network into a format comprehendible by the various types of external devices, systems, database, software, and services. In some such examples, the command conversion process may be the similar to the conversion process explained above, but with the commands being the information received and the converted commands being the information transmitted to the external devices, systems, database, software, and services.

In some examples, the communication between the network and connected devices via the reality host may be asynchronous. In some examples, the communication between the network and connected devices via the reality host may be event-driven. In some examples, the communication between the network and connected devices via the reality host may be asynchronous and event-driven.

The systems, methods, and apparatuses described herein are designed to scale with the addition of numerous reality hosts, which may be automatically discovered and/or created and integrated. In some examples, reality hosts may manage their own state and may coordinate with each other when necessary. In some such examples, each reality host may maintain its own communication channel while coordinating with others. When multiple reality hosts are integrated with a network, the reality hosts may collectively contribute to a unified model of reality that the network can utilize for decision-making. Each reality host may provide a unique embodied perspective, creating a rich tapestry of experiences across different physical, virtual, and digital spaces. In some examples, the unified model may maintain temporal-spatial relationships between events, allowing the network to understand causality and context based on where and when events occurred. In some examples, the reality hosts may provide overlapping perspectives of a same space or event, enabling the network to build a more nuanced and accurate understanding of reality. Unlike traditional context windows that provide flat, disconnected information, this unified model may preserve the embodied nature of each experience. Overall, the network's engagement with multiple reality hosts may enable the learning of environmental patterns and user preferences over time to improve contextual understanding. Based on feedback on action outcomes and performance from multiple reality hosts, the network may be able to build causal models.

In some examples, the network integration with multiple reality hosts may provide a bidirectional state synchronization with the network's internal state influencing reality host behavior and the reality host's state changes updating network's reality model. In some such examples, the network and reality hosts may be part of a continuous feedback loop for learning from interactions.

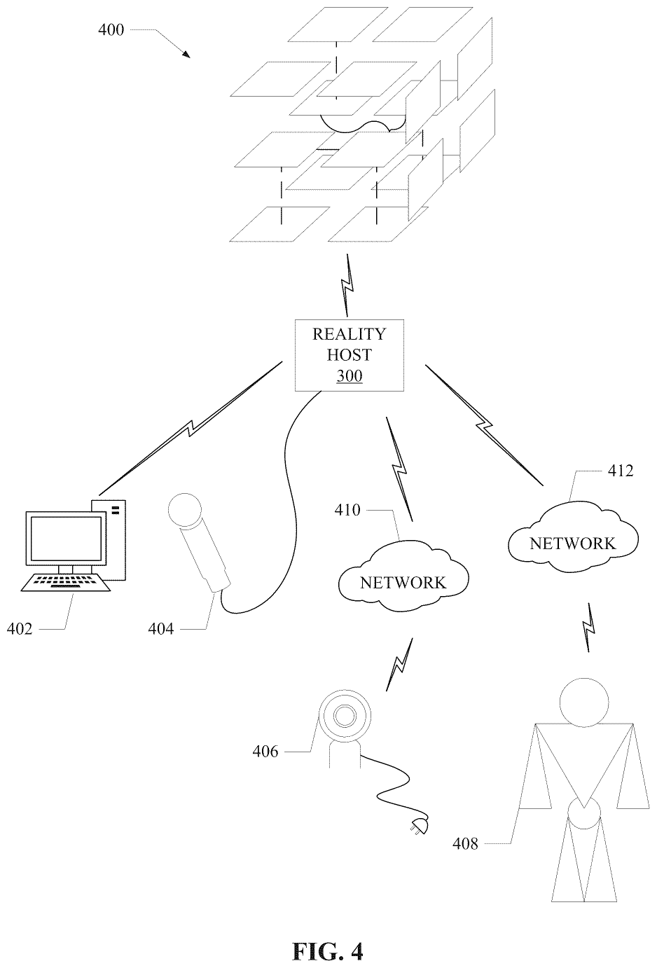

As shown in FIG. 4, a network 400 may have a single reality host 300 that may communicate with multiple devices. In some examples, the reality host 300 may reside on a same device (or set of devices) as the network 400. In some examples, the reality host 300 may communicate (wired or wirelessly) with the reality host 300. In some examples, the reality host 300 may communicate (wired or wirelessly) with one or more devices. As illustrated in FIG. 4, the reality host 300 communicate with a personal computer 402. In some examples, the reality host 300 may communicate with the personal computer 402 wirelessly. In some examples the reality host 300 may communicate with a microphone 404. In the illustrated example of FIG. 4, the reality host 300 may communicate with microphone 404 via wired connection. In some examples, the reality host 300 may communicate with a camera 406 and a humanoid robot 408. In some examples, the reality host 300 may communicate with the camera 406 via a network 410, either wired or wirelessly. In some examples, the reality host 300 may communicate with the humanoid robot 408 via a network 412, either wired or wirelessly. In some examples, the network 410 and the network 412 may be a same network, such as the Internet. In the illustrated example of FIG. 4, a single reality host 300 may be able to interface and interact with each of the personal computer 402, the microphone 404, the camera 406, the humanoid robot 408, and convert the information received therefrom into compatible information for the network 400. Of course, any number of devices of any type may communicate with the network 400, and the example devices of FIG. 4 are provided for illustrative purposes that should not be limiting on this disclosure.

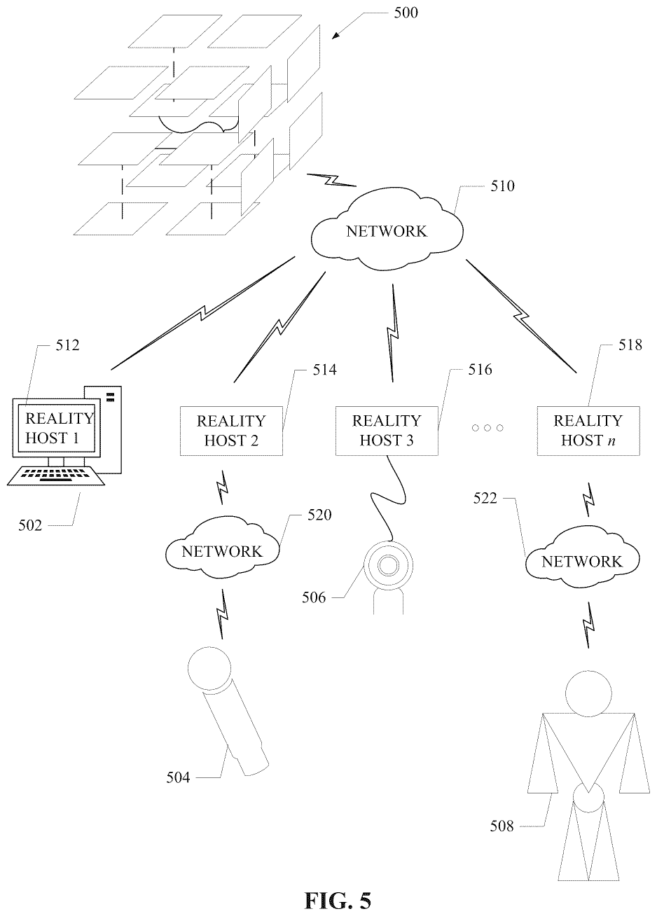

Turning now to FIG. 5, a network 500 may have multiple (e.g., n) reality hosts in communication therewith, with each reality host being associated with a particular device. As illustrated in FIG. 5, the network 500 may communicate with a personal computer 502, a microphone 504, a camera 506, and a humanoid robot 508. As discussed with reference to FIG. 4, any number of devices of any type may communicate with the network 500, and the example devices of FIG. 5 are provided for illustrative purposes that should not be limiting on this disclosure. In some examples, the network 500 may communicate with the personal computer 502, the microphone 504, the camera 506, and the humanoid robot 508, via a network 510. In some examples, the network 510 may be the Internet. In some examples, the network 510 may be a local area network. In some examples, the network 510 may be a Bluetooth network comprising the personal computer 502, the microphone 504, the camera 506, and the humanoid robot 508 devices. In some examples, each of the devices illustrated in FIG. 5 may be associated with their own reality host connected in various manners. For example the personal computer 502 may be associated with a first reality host 512. In the illustrated example of FIG. 5, the first reality host 512 may reside on the personal computer 502. The microphone 504 may be associated with a second reality host 514. The camera 506 may be connected via wired connection to the third reality host 516. The humanoid robot 508 may be associated with an nth reality host 518. The second reality host 514 may communicate with the microphone 504 via a wired or wireless network 520. In some such examples, the network 500 may communicate with the second reality host 514 via the network 510, and the second reality host 514 may communicate with the microphone 504 via the network 520. The nth reality host 518 may communicate with the humanoid robot 508 via a wired or wireless network 522. In some such examples, the network 500 may communicate with the nth reality host 518 via the network 510, and the nth reality host 518 may communicate with the humanoid robot 508 via the network 522. In some examples, the network 510, the network 520, and the network 522 may be a same network such as, for example, the Internet. Thus in the illustrated example of FIG. 5, the network 500 may receive information from various devices via various reality hosts. Each reality host may be associated with a single device, and may comprise information conversion mechanisms for the specific information received or input into those specific devices. In some examples, the networks 400, 500 may be able to generate code to program a new reality host for integration with a new device. In some such examples, the networks may prompt an inference engine (e.g., LLM) to generate the code for the new reality host. In some examples, an existing reality host 300 may transmit the generated reality host program to the new device. Upon authentication, installation, and/or integration of the reality host program, the new reality host may interact with the device and the network in a similar manner as described with respect to the reality hosts described herein. In some such examples, the network and reality hosts may scale autonomously.

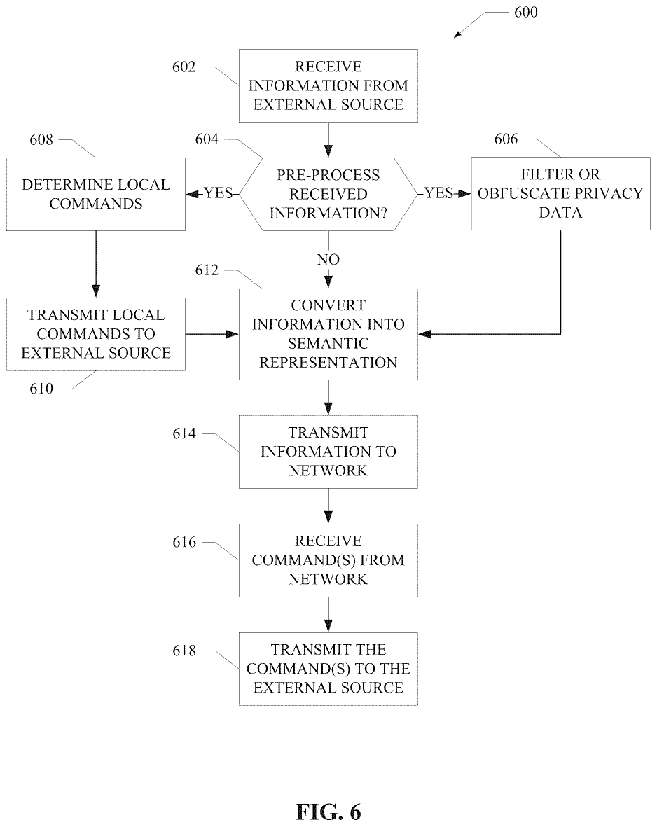

FIG. 6 is a flowchart illustrating a process 600 implemented by the reality hosts 300 described herein. The example process 600 may begin at step 602 where the information receiver 302 may receive information from an external source (e.g., a device or software service). In some examples, the received information may be device capability information, sensor information, data from a database, or the like. At step 604, the edge processor 310 may analyze the information to determine whether to perform pre-processing of the information. If the edge processor 310 determines to perform pre-processing of the information (step 604: YES), the process 600 may proceed to steps 606 and 608. At step 606, the edge processor 310 may filter out or obfuscate personal identifying information, confidential information, or other privacy data. At step 608, the edge processor 310 may process the information associated with real-time requests and other emergency conditions to determine one or more local commands to be executed by the external source. At step 610, the information transmitter 308 may transmit the one or more local commands to the external source for execution.

If the edge processor 310 determines not to perform pre-processing of the information (step 604: NO), or subsequent to steps 606 and/or 610, the process 600 may proceed to step 612. At step 612, the information converter 306 may convert the (pre-processed) information into semantic representations or understandings comprehendible by a network. In some examples, the information converter 306 may utilize the conversion database 304 to convert the information. In some examples, the information converter 306 may prompt an inference engine to convert the information. At step 614, the information transmitter 308 may transmit the converted information to the network for processing. At step 616, the information receiver 302 may receive one or more commands from the network. In some examples, the one or more commands may be based on the converted information transmitted at step 614. At step 618, the information transmitter 308 may transmit the one or more commands to the external source. In some examples, the information converter 306 may convert the one or more commands into a format comprehendible by the external source. In some such examples, this conversion may be the reverse of the conversion process of step 612. The example process 600 may be repeated continuously as information is received from one or more external sources.

As an example, a network may integrate with numerous reality hosts associated with temperature sensors around the world in order to monitor the weather and communicate weather forecasts with consumers. In some examples, the reality host may become a software service. In some examples, the reality hosts may interact with one or more different weather services via APIs, HTTP. In this example, the network may be able to receive weather information, including raw data, push notifications about emergency alerts, wind location, from various sources around the world, combine multiple different patterns from different weather systems and APIs format the data into a weather forecast. In some examples, the various different reality hosts deployed around the world may create a virtual fluid field around the earth enabling a consumer (or the network) to identify any place around the earth and the network may determine the temperature, wind, weather alerts, forecasts, etc. in that location and provide that information to the consumer. In effect, the network may be able to sense the weather around the earth much like a human senses their environment.

In some examples the reality hosts may collect data and provide it to the network in a multidimensional layer field, matrix, vector, or any combination thereof. For example, the reality host may populate, based on hundreds of different API calls, a simple matrix with millions of weather parameters. In some examples, the data may be visualized in a three dimensional model. Based on this information, the underlying network may be able to build models based on the weather data and predict future weather.

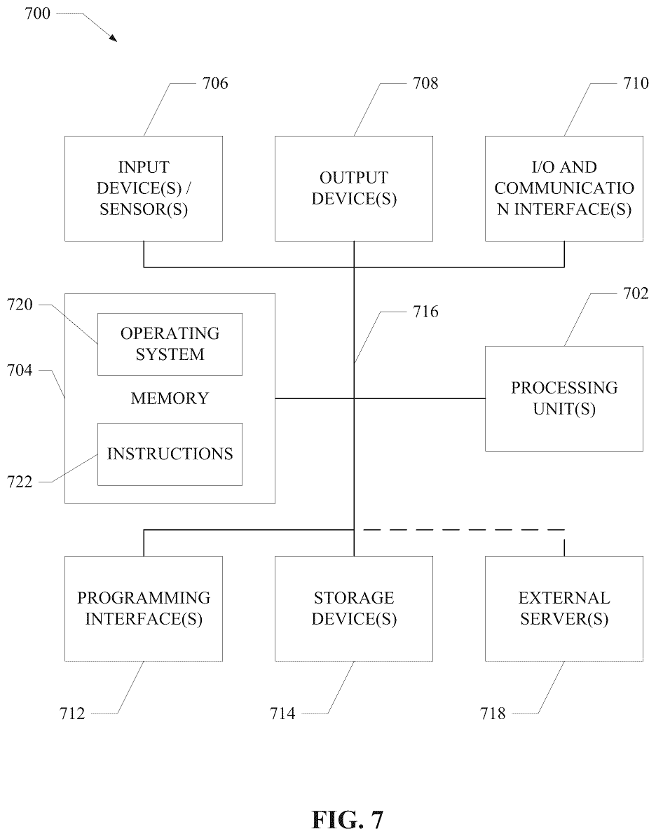

FIG. 7 illustrates an example computing device 700 that may be used in accordance with the teachings described herein. The example computing device 700 may be a computer, a tablet, a mobile device, a server, a workstation, an internet-of-things (IoT) device, a smart appliance, a network node, a hub, a router, a modem, or the like. The example computing device 700 may comprise one or more processing units 702, one or more memory 704, one or more input devices or sensors 706, one or more output devices 708, one or more input/output (I/O) and communication interfaces 710, one or more programming interfaces 712, and one or more storage devices 714. Each of the one or more processing units 702, one or more memory 704, one or more input devices or sensors 706, one or more output devices 708, one or more input/output (I/O) and communication interfaces 710, one or more programming interfaces 712, and one or more storage devices 714 may be interconnected via wired connections such as, for example, a bus 716. Alternatively, each of the one or more processing units 702, one or more memory 704, one or more input devices or sensors 706, one or more output devices 708, one or more input/output (I/O) and communication interfaces 710, one or more programming interfaces 712, and one or more storage devices 714 may be interconnected wirelessly. In some examples, each of the one or more processing units 702, one or more memory 704, one or more input devices or sensors 706, one or more output devices 708, one or more input/output (I/O) and communication interfaces 710, one or more programming interfaces 712, and one or more storage devices 714 may be interconnected via a combination of wired and wireless connections. In some examples, the example computing device 700 may be connected to one or more external servers 718.

In some examples, the processing unit 702 may be a processor such as a central processing unit (CPU), a microprocessor, integrated circuit (IC), an application-specific integrated circuit (ASIC), a Field Programmable Gate Array (FPGA), a graphical processing unit (GPU), a quantum processor, a bioprocessor, a vector processor, a graph processor, or the like. In some examples, the computing device 700 may have one or more processing units 702 for parallel processing. In some such examples, the one or more processing units 702 may be of the same type (e.g., multiple microprocessors). In some examples, the one or more processing units 702 may be of different types (e.g., at least one CPU and at least one GPU). In some examples, the generative neural networks 100, 200, and reality host 300 may be implemented by the processing unit 702.

In some examples, the memory 704 may be a non-transitory computer readable storage medium. In some examples, the memory 704 may include random-access memory, such as DRAM, SRAM, DDR RAM, or other random-access solid-state memory devices. In some examples, the memory 704 may include an operating system 720 and instructions 722.

The operating system 720 may be a traditional operating system that relies on pre-defined rules and structures such as, for example, Microsoft Windows®, Linux, macOS, etc. The operating system 720 may be able to function effectively on a wide range of devices and platforms including smartphones, tablets, desktops, servers, etc. In some examples, the operating system 720 may be decentralized, such that users may share resources and may collaborate without reliance on centralized servers. The instructions 722 may comprise computer executable instruction sets for implementing the example process 600.

In some examples, the one or more input devices or sensors 706 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 708 may comprise one or more displays, one or more speakers, one or more lights (e.g., light emitting diodes), a signal generator, a haptics engine, a printer, or the like.

In some examples, the one or more I/O and communication interfaces 710 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, I2C, or a similar type of interface.

In some examples, the one or more programming interfaces 712 may comprise software for implementing one or more physical I/O and communication interfaces, APIs configured for communication with and providing services to databases, software applications, the Internet, or the like.

In some examples, the one or more storage devices 714 may comprise non-volatile memory, such as one or more magnetic disk storage devices, optical disk storage devices, flash memory devices, or other non-volatile solid-state storage devices. In some examples, the one or more storage devices 714 may include one or more databases.

In some examples, the one or more external servers 718 may comprise external processing and storage that may be utilized by the example computing device 700. In some examples, the one or more external servers 718 may be configured similarly to the example computing device 700.

One or more example apparatus, systems, and computer-readable storage mediums are described below.

An example system may comprise a network with one or more cognitive nodes, at least one device or software service, one or more processors, and memory storing instructions that, when executed by the one or more processors, cause receiving, from the at least one device or software service device or software service capability information, and device or software service data.

Some systems further comprise instructions that when executed cause semantically processing, based on the device or software service capability information, the device or software service data to determine one or more semantic understandings.

Some systems further comprise instructions that when executed cause transmitting the one or more semantic understandings to the network.

Some systems further comprise instructions that when executed cause receiving, from the network and based on the transmitted one or more semantic understandings, one or more commands.

Some systems further comprise instructions that when executed cause transmitting, to the at least one device or software service, the one or more commands.

In some systems wherein the one or more commands are first commands, the instructions, when executed by the one or more processors, further cause, after receiving and before semantically processing the device or software service data, pre-processing the device or software service data.

In some systems wherein the one or more commands are first commands, the instructions, when executed by the one or more processors, further cause locally determining, based on the device or software service data, one or more second commands for execution in real-time, and transmitting the one or more second commands to the at least one device or software service.

Some systems further comprise instructions that, when executed by the one or more processors, further cause filtering, from the device or software service data, personally identifiable information.

Some systems further comprise instructions that, when executed by the one or more processors, further cause generating a reality host for integration with at least one new device or software service.

In some systems a first command, of the one or more commands, causes the at least one device or software service to autonomously perform numerous tasks.

In some systems, a second command, of the one or more commands, causes the at least one device or software service to perform a single task.

An example computer readable storage medium may store instructions that, when executed, cause receiving, from at least one device or software service device or software service capability information, and device or software service data.

Some computer readable storage mediums may be non-transitory.

Some computer readable storage mediums may store instructions that, when executed, cause semantically processing, based on the device or software service capability information, the device or software service data to determine one or more semantic understandings.

Some computer readable storage mediums may store instructions that, when executed, cause transmitting the one or more semantic understandings to a network.

Some computer readable storage mediums may store instructions that, when executed, cause receiving, from the network and based on the transmitted one or more semantic understandings, one or more commands.

Some computer readable storage mediums may store instructions that, when executed, cause transmitting, to the at least one device or software service, the one or more commands.

Some computer readable storage mediums may store instructions that, when executed, cause, after receiving and before semantically processing the device or software service data, pre-processing the device or software service data.

Some computer readable storage mediums may store instructions that, when executed, cause locally determining, based on the device or software service data, one or more second commands for execution in real-time, and transmitting the one or more second commands to the at least one device or software service.

Some computer readable storage mediums may store instructions that, when executed, cause filtering, from the device or software service data, personally identifiable information.

Some computer readable storage mediums may store instructions that, when executed, cause generating a reality host for integration with at least one new device or software service.

In some computer readable storage mediums, a first command, of the one or more commands, causes the at least one device or software service to autonomously perform numerous tasks.

In some computer readable storage mediums, a second command, of the one or more commands, causes the at least one device or software service to perform a single task.

An example method may comprise receiving, from at least one device or software service device or software service capability information, and device or software service data, semantically processing, based on the device or software service capability information, the device or software service data to determine one or more semantic understandings, transmitting the one or more semantic understandings to a network, receiving, from the network and based on the transmitted one or more semantic understandings, one or more commands, and transmitting, to the at least one device or software service, the one or more commands.

Some methods further comprise, after receiving and before semantically processing the device or software service data, pre-processing the device or software service data.

Some methods further comprise locally determining, based on the device or software service data, one or more second commands for execution in real-time, and transmitting the one or more second commands to the at least one device or software service.

Some methods further comprise filtering, from the device or software service data, personally identifiable information.

Some methods further comprise generating a reality host for integration with at least one new device or software service.

In some methods, a first command, of the one or more commands, causes the at least one device or software service to autonomously perform numerous tasks.

In some methods, a second command, of the one or more commands, causes the at least one device or software service to perform a single task.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system comprising:
a network comprising one or more cognitive nodes;
at least one device or software service;
one or more processors; and
memory storing instructions that, when executed by the one or more processors, cause:
receiving, from the at least one device or software service:
device or software service capability information, and
device or software service data;
semantically processing, based on the device or software service capability information, the device or software service data to determine one or more semantic understandings;
transmitting the one or more semantic understandings to the network;
receiving, from the network and based on the transmitted one or more semantic understandings, one or more commands; and
transmitting, to the at least one device or software service, the one or more commands.

2. The system of claim 1, wherein the one or more commands are first commands, and wherein the instructions, when executed by the one or more processors, further cause:
after receiving and before semantically processing the device or software service data, pre-processing the device or software service data.

3. The system of claim 1, wherein the one or more commands are first commands, and wherein the instructions, when executed by the one or more processors, further cause:
locally determining, based on the device or software service data, one or more second commands for execution in real-time; and
transmitting the one or more second commands to the at least one device or software service.

4. The system of claim 1, wherein the instructions, when executed by the one or more processors, further cause:
filtering, from the device or software service data, personally identifiable information.

5. The system of claim 1, wherein the instructions, when executed by the one or more processors, further cause:
generating a reality host for integration with at least one new device or software service.

6. The system of claim 1, wherein a first command, of the one or more commands, causes the at least one device or software service to autonomously perform numerous tasks.

7. The system of claim 1, wherein a second command, of the one or more commands, causes the at least one device or software service to perform a single task.

8. A computer readable storage medium storing instructions that, when executed, cause:
receiving, from at least one device or software service:
device or software service capability information, and
device or software service data;
semantically processing, based on the device or software service capability information, the device or software service data to determine one or more semantic understandings;
transmitting the one or more semantic understandings to a network;
receiving, from the network and based on the transmitted one or more semantic understandings, one or more commands; and
transmitting, to the at least one device or software service, the one or more commands.

9. The storage medium of claim 8, wherein the one or more commands are first commands, and wherein the instructions, when executed, further cause:
after receiving and before semantically processing the device or software service data, pre-processing the device or software service data.

10. The storage medium of claim 8, wherein the one or more commands are first commands, and wherein the instructions, when executed, further cause:
locally determining, based on the device or software service data, one or more second commands for execution in real-time; and
transmitting the one or more second commands to the at least one device or software service.

11. The storage medium of claim 8, wherein the instructions, when executed, further cause:
filtering, from the device or software service data, personally identifiable information.

12. The storage medium of claim 8, wherein the instructions, when executed, further cause:
generating a reality host for integration with at least one new device or software service.

13. The storage medium of claim 8, wherein a first command, of the one or more commands, causes the at least one device or software service to autonomously perform numerous tasks.

14. The storage medium of claim 8, wherein a second command, of the one or more commands, causes the at least one device or software service to perform a single task.

15. A method comprising:
receiving, from at least one device or software service:
device or software service capability information, and
device or software service data;
semantically processing, based on the device or software service capability information, the device or software service data to determine one or more semantic understandings;
transmitting the one or more semantic understandings to a network;
receiving, from the network and based on the transmitted one or more semantic understandings, one or more commands; and
transmitting, to the at least one device or software service, the one or more commands.

16. The method of claim 15, further comprising:
after receiving and before semantically processing the device or software service data, pre-processing the device or software service data.

17. The method of claim 15, further comprising:
locally determining, based on the device or software service data, one or more second commands for execution in real-time; and
transmitting the one or more second commands to the at least one device or software service.

18. The method of claim 15, further comprising:
filtering, from the device or software service data, personally identifiable information.

19. The method of claim 15, further comprising:
generating a reality host for integration with at least one new device or software service.

20. The method of claim 15, wherein:
a first command, of the one or more commands, causes the at least one device or software service to autonomously perform numerous tasks; and
a second command, of the one or more commands, causes the at least one device or software service to perform a single task.
